(19) United States
(12) Patent Application Publication
(10) Pub. No.: US 2015/0032444 A1
(43) Pub. Date: Jan. 29, 2015

(54) CONTEXTUAL ANALYSIS DEVICE AND CONTEXTUAL ANALYSIS METHOD

(71) Applicants: KABUSHIKI KAISHA TOSHIBA, Tokyo (JP); TOSHIBA SOLUTIONS CORPORATION, Kawasaki-shi (JP)

(72) Inventor: Shinichiro Hamada, Yokohama (JP)

(21) Appl. No.: 14/475,700

(22) Filed: Sep. 3, 2014

Related U.S. Application Data
(63) Continuation of application No. PCT/JP2012/066182, filed on Jun. 25, 2012.

(51) Int. Cl. G06F 17/27; G06F 17/28

(52) U.S. Cl. CPC G06F 17/2785; G06F 17/28
USPC 704/9

(57) ABSTRACT

According to an embodiment, a contextual analysis device includes a generator, an predictor, and a processor. The generator is configured to generate, from a target document for analysis, an predicted sequence in which some elements of a sequence having elements arranged therein are obtained by prediction. Each element is a combination of a predicate having a common argument, word sense identification information of the predicate, and case classification information indicating a type of the common argument. The predictor is configured to predict an occurrence probability of the predicted sequence based on a probability of appearance of the sequence that is acquired in advance from an arbitrary group of documents and that is matching with the predicted sequence. The processor is configured to perform contextual analysis with respect to the target document by using the predicted occurrence probability of the predictepredictord sequence.

### CROSS-REFERENCE TO RELATED APPLICATION

This application is a continuation of International Application No. PCT/JP2012/066182, filed on Jun. 25, 2012, the entire contents of which are incorporated herein by reference.

### FIELD

Embodiments described herein relate generally to a contextual analpredictionysis device, which performs contextual analysis, and a contextual analysis method.

### BACKGROUND

In natural language processing, performing contextual analysis such as anaphora resolution, coreference resolution, and dialog processing is an important task for the purpose of correctly understanding a document. It is a known fact that the use of procedural knowledge, such as the notion of script by Schank and the notion of frame by Fillmore, in contextual analysis proves effective. However, as far as manually-created procedural knowledge is concerned, there is a limitation of coverage. In that regard, there is an attempt to enable automatic acquisition of such procedural knowledge from the document.

For example, a method has been proposed in which a sequence of mutually-related predicates (hereinafter, called an “event sequence”) is treated as procedural knowledge; and event sequences are acquired from an arbitrary group of documents and used as procedural knowledge.

However, event sequences acquired in the conventional manner lack in the accuracy as far as procedural knowledge is concerned. Hence, if contextual analysis is performed using event sequences, then there are times when a sufficient accuracy is not achieved. That situation needs to be improved.

### BRIEF DESCRIPTION OF THE DRAWINGS

FIG. 1 is an example of inter-sentential anaphora in English language;

FIG. 2 is a diagram for explaining a specific example of an event sequence acquired according to a conventional method;

FIG. 3 is a diagram for explaining issues faced in the event sequence acquired according to a conventional method;

FIG. 4 is a diagram illustrating a portion extracted from the Kyoto University Case Frames;

FIG. 5 is a block diagram illustrating a configuration example of a contextual analysis device according to an embodiment;

FIGS. 6A and 6B are diagrams of examples of anaphora-tagged groups of documents;

FIG. 7 is a block diagram illustrating a configuration example of a case frame predictor;

FIGS. 8A and 8B are diagrams illustrating examples of post-case-frame-prediction documents;

FIG. 9 is a block diagram illustrating a configuration example of an event sequence model builder;

FIGS. 10A and 10B are diagrams of examples of coreference-tagged documents;

FIGS. 11A and 11B are diagrams illustrating examples of event sequences acquired from the coreference-tagged documents illustrated in FIG. 10;

FIGS. 12A and 12B are diagrams illustrating portions of frequency lists obtained from the event sequences illustrated in FIG. 11;

FIGS. 13A and 13B are diagrams illustrating probability lists that are the output of probability models built using the frequency lists illustrated in FIG. 12;

FIG. 14 is a block diagram illustrating a configuration example of a machine-learning case example generator;

FIGS. 15A and 15B are diagrams illustrating examples of anaphora-tagged sentences;

FIG. 16 is a diagram illustrating a standard group of features that is generally used as the elements of a feature vector representing the pair of an anaphor candidate and an antecedent candidate;

FIG. 17 is a diagram illustrating an example of case example data for training;

FIG. 18 is a schematic diagram for conceptually explaining an operation of determining the correctness of a case example by performing machine learning with a binary classifier; and

FIG. 19 is a diagram illustrating an exemplary hardware configuration of the contextual analysis device.

### DETAILED DESCRIPTION

According to an embodiment, a contextual analysis device includes an predicted-sequence generator, a probability predictor, and an analytical processor. The predicted-sequence generator is configured to generate, from a target document for analysis, an predicted sequence in which some elements of a sequence having a plurality of elements arranged therein are obtained by prediction. Each element is a combination of a predicate having a common argument, word sense identification information for identifying word sense of the predicate, and case classification information indicating a type of the common argument. The probability predictor is configured to predict an occurrence probability of the predicted sequence based on a probability of appearance of the sequence that is acquired in advance from an arbitrary group of documents and that is matching with the predicted sequence. The analytical processor is configured to perform contextual analysis with respect to the target document for analysis by using the predicted occurrence probability of the predicted sequence.

An exemplary embodiment of a contextual analysis device and a contextual analysis method is described below with reference to the accompanying drawings. The embodiment described below is an example of application to a device that particularly performs anaphora resolution as contextual analysis.

Anaphora points to a phenomenon in which a particular linguistic expression indicates the same content or the same entity as a preceding expression in the document. While expressing an anaphoric relationship, instead of repeating the same word, either a pronoun is used or the word at trailing positions is omitted. The former method is called pronoun anaphora, while the latter method is called zero anaphora. In regard to pronoun anaphora, predicting the target indicated by the pronoun is anaphora resolution. Similarly, in regard to zero anaphora, complementing the nominal that has been omitted in zero anaphora (i.e., complementing the zero pronoun) is anaphora resolution. Anaphora includes intra-sentential anaphora in which the anaphor such as a pronoun or a zero pronoun indicates the target within the same sentence, and includes inter-sentential anaphora in which the target indicated by the anaphor is present in a different sentence. Generally, anaphora resolution of inter-sentential anaphora is a more difficult task than anaphora resolution of intra-sentential anaphora. In a document, anaphora is found on a frequent basis, and provides significant clues that facilitate understanding of meaning and context. For that reason, as far as natural language processing is concerned, anaphora resolution is a valuable technology.

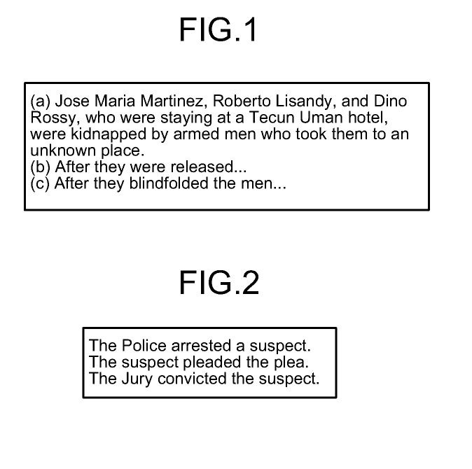

FIG. 1 is an example of inter-sentential anaphora in English language (D. Bean and E. Riloff 2004 Unsupervised learning of contextual role knowledge for coreference resolution. In “Proc. of HLT/NAACL”, pages 297. 304.). In the example illustrated in FIG. 1, the pronoun “they” written in a sentence (b) as well as the pronoun “they” written in a sentence (c) represents “Jose Maria Martinez, Roberto Lisandy, and Dino Rossy” written in a sentence (a); and predicting the relationship therebetween is anaphora resolution.

While performing such anaphora resolution, the use of procedural knowledge proves effective. That is because procedural knowledge can be used as one of the indicators in evaluating the accuracy of anaphora resolution. As a method of automatically acquiring such procedural knowledge, a method is known in which an event sequence, which is a sequence of predicates having a common argument, is acquired from an arbitrary group of documents. This is based on the hypothesis that terms having a common argument are in some kind of relationship with each other. Herein, a common argument is called an anchor.

Herein, regarding an event sequence that is acquired by implementing the conventional method, a specific example is given with reference to example sentences illustrated in FIG. 2 (N. Chambers and D. Jurafsky. 2009. Unsupervised learning of narrative schemas and their participants. In “Proceedings of the Joint Conference of the 47th Annual Meeting of the ACL and the 4th International Joint Conference on Natural Language Processing of the AFNLP: Volume 2-Volume 2”, pages 602. 610. Association for Computational Linguistics.).

In the example illustrated in FIG. 2, “suspect” serves as the anchor. In the first sentence illustrated in FIG. 2, the predicate is “arrest”, and the case type of “suspect” that is the anchor is objective case (obj). Similarly, in the second sentence illustrated in FIG. 2, the predicate is “plead”, and the case type of “suspect” that is the anchor is subjective case (sbj). Moreover, in the third sentence illustrated in FIG. 2, the predicate is “convict”, and the case type of “suspect” that is the anchor is objective case (obj).

In the conventional method, the predicate is extracted from each of a plurality of sentences that includes the anchor. Then, with each pair of an extracted predicate and case classification information (hereinafter, called a “case type”), which indicates the type of the case of the anchor in that sentence, serving as an element; a sequence is acquired as an event sequence in which a plurality of elements is arranged in order of appearance of the predicates. From the example sentences illustrated in FIG. 2, [arrest#obj, plead#sbj, convict#obj] is acquired as the event sequence. In this event sequence, each portion separated by a comma serves as an element of the event sequence.

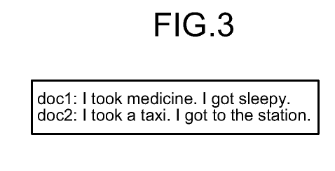

However, in the event sequence acquired in the conventional method, the same predicate used with different word senses is not distinguished according to the word sense. That leads to a lack of accuracy as far as procedural knowledge is concerned. Regarding a polysemous predicate, sometimes there is a significant change in the meaning depending on the case of the predicate. However, in the conventional method, even if the predicate is used with different word senses, it is not distinguished according to the word sense. Hence, there are times when a case example of an event sequence that is not supposed to be identified gets identified. For example, in the example sentences illustrated in FIG. 3, doc1 and doc2 are two different sentences. According to the conventional method, if an event sequence having “I” as the anchor is acquired from each sentence, then an identical event sequence expressed as [take#sbj, get#sbj] is acquired. In this way, in the conventional method, there are times when an identical event sequence is acquired from two sentences having totally different meanings. Therefore, the event sequence that is acquired lacks in the accuracy as far as procedural knowledge is concerned. Hence, if anaphora resolution is performed using such an event sequence, then there are times when sufficient accuracy is not achieved. That situation needs to be improved.

In that regard, in the embodiment, a new type of event sequence is proposed in which each element constituting the event sequence not only has a predicate and the case classification information attached thereto but also has word sense identification information attached thereto that enables identification of the word sense of that predicate. In this new-type event sequence, because of the word sense identification information attached to each element, it becomes possible to avoid the ambiguity in the word sense of the corresponding predicate. That enables achieving enhancement in the accuracy as far as procedural knowledge is concerned. Thus, when this new-type event sequence is used in anaphora resolution, it becomes possible to enhance the accuracy of anaphora resolution.

In the embodiment, in order to identify the word sense of a predicate, a “case frame” is used as an example. In a case frame, cases acquirable with reference to a predicate and the restrictions related to the values of the cases are written for each category of predicate usage. For example, there exists data of case frames called “Kyoto University Case Frames” (Daisuke Kawahara and Sadao Kurohashi, Case Frame Compilation from the Web using High-Performance Computing, The Information Processing Society of Japan: Natural Language Processing Research Meeting 171-12, pp. 67-73, 2006.), and it is possible to use those case frames.

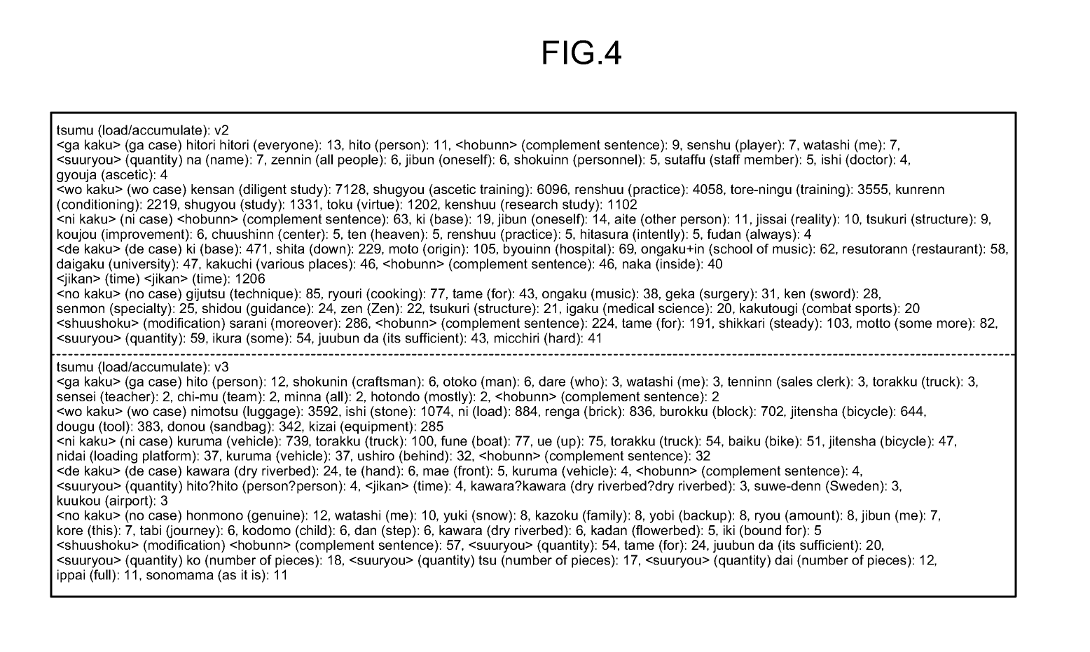

In FIG. 4 is illustrated a portion extracted from the Kyoto University Case Frames. As illustrated in FIG. 4, a predicate having a plurality of word senses (usages) is classified according to the word sense; and, for each case type, the nouns related to each word sense are written along with the respected frequencies of appearance. In the example illustrated in FIG. 4, a predicate “tsumu” (load/accumulate) that is matching on the surface is classified into a word sense (usage) identified by a label called “dou2” (v2) and a word sense (usage) identified by a label called “dou3” (v3); and, for each case type, the group of nouns related in the case of using each word sense is written along with the frequencies of appearance of the nouns.

In the case of using the Kyoto University Case Frames, the labels such as “dou2” (v2) and “dou3” (v3), which represent the word senses of a predicate, can be used as the word sense identification information to be attached to each element of the new-type event sequence. In the event sequence in which the elements have the word sense identification information attached thereto, different word sense identification information is attached to the elements of a predicate having different word senses. Hence, it becomes possible to avoid event sequence mix-up caused due to the polysemy of predicates. That enables achieving enhancement in the accuracy as far as procedural knowledge is concerned.

Regarding an event sequence acquired from an arbitrary group of documents, the probability of appearance can be obtained using a known statistical tool and can be used as one of the indicators in evaluating the accuracy of anaphora resolution. In the conventional method, in order to obtain the probability of appearance of an event sequence, point-wise mutual information (PMI) of pairs of elements constituting the event sequence is mainly used. However, in the conventional method of using PMI of pairs of elements, it is difficult to accurately obtain the probability of appearance of the event sequence that is effective as procedural knowledge.

In that regard, in order to obtain the frequency of appearance or the probability of appearance of an event sequence; for example, a number of probability models that have been devised in the field of language models are used. For example, the n-gram model in which the order of elements is taken into account, the trigger model in which the order of elements is not taken into account, and the skip model in which it is allowed to have combinations of elements that are not adjacent to each other are used. Such probability models have the characteristic of being able to handle the probability with respect to sequences having arbitrary lengths. Moreover, in order to deal with unknown event sequences, it is possible to perform smoothing that has been developed in the field of language models.

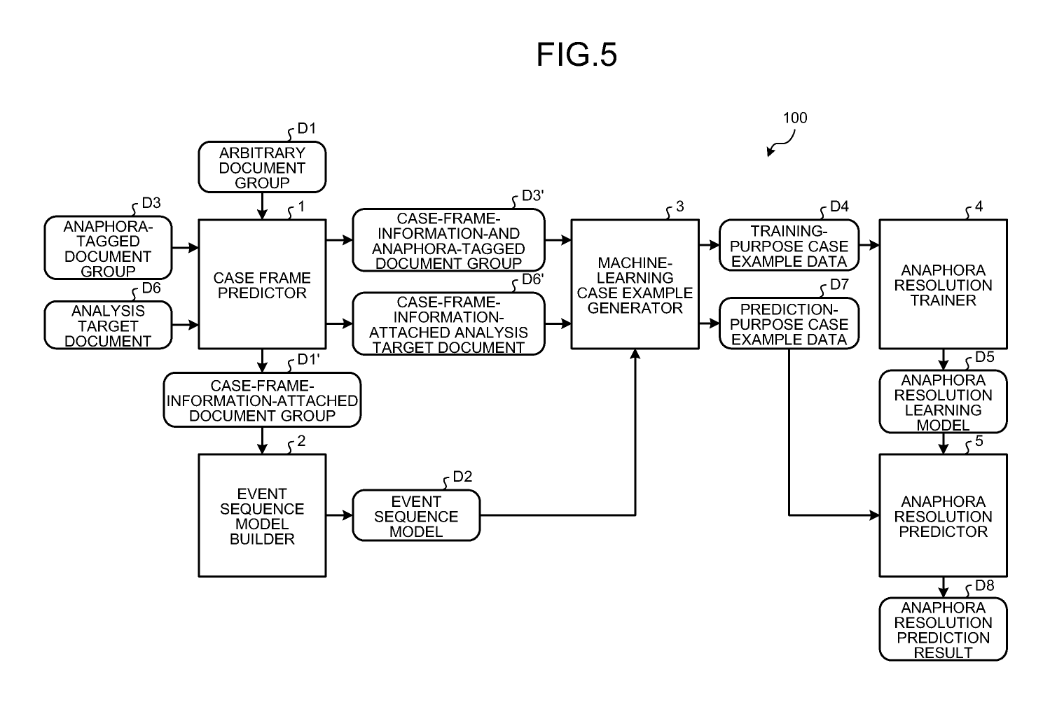

Given below is the explanation of a specific example of a contextual analysis device according to the embodiment. FIG. 5 is a block diagram illustrating a configuration example of a contextual analysis device 100 according to the embodiment. As illustrated in FIG. 5, the contextual analysis device 100 includes a case frame predictor 1, an event sequence model builder 2, a machine-learning case example generator 3, an anaphora resolution trainer 4, and an anaphora resolution predictor (an analytical processing unit) 5. Meanwhile, in FIG. 5, round-cornered quadrilaterals represent input-output data of the constituent elements 1 to 5 of the contextual analysis device 100.

The operations performed in the contextual analysis device 100 are broadly divided into three operations, namely, “an event sequence model building operation”, “an anaphora resolution learning operation”, and “an anaphora resolution predicting operation”. In the event sequence model building operation, an event sequence model D2 is generated from an arbitrary document group D1 using the case frame predictor 1 and the event sequence model builder 2. In the anaphora resolution learning operation, training-purpose case example data D4 is generated from an anaphora-tagged document group D3 and the event sequence model D2 using the case frame predictor 1 and the machine-learning case example generator 3, and then an anaphora resolution learning model D5 is generated from the training-purpose case example data D4 using the anaphora resolution trainer 4. In the anaphora resolution predicting operation, prediction-purpose case example data D7 is generated from an analysis target document D6 and the event sequence model D2 using the case frame predictor 1 and the machine-learning case example generator 3, and then an anaphora resolution prediction result D8 is generated from the training-purpose case example data D4 and the anaphora resolution learning model D5 using the anaphora resolution predictor 5.

In the embodiment, for ease of explanation, it is assumed that a binary classifier is used as the technique of machine learning. However, instead of using a binary classifier, it is possible to implement any other known method such as ranking learning as the technique of machine learning.

Firstly, the explanation is given about a brief overview of the three operations mentioned above. At the time of performing the event sequence model building operation in the contextual analysis device 100, the arbitrary document group D1 is input to the case frame predictor 1. Thus, the case frame predictor 1 receives the arbitrary document group D1; predicts, with respect to each predicate included in the arbitrary document group D1, a case frame to which that predicate belongs; and outputs case-frame-information-attached document group D1′ in which case frame information representing a brief overview of the top-k candidate case frames is attached to each predicate. Meanwhile, the detailed explanation of a specific example of the case frame predictor 1 is given later.

Subsequently, the event sequence model builder 2 receives the case-frame-information-attached document group D1′ and acquires a group of event sequences from the case-frame-information-attached document group D1′. Then, with respect to the group of event sequences, the event sequence model builder 2 performs frequency counting and probability calculation and eventually outputs the event sequence model D2. Herein, the event sequence model D2 represents the probability of appearance of each sub-sequence included in the group of event sequences. As a result of using the event sequence model D2, it becomes possible to decide on the probability value of an arbitrary sub-sequence. This feature is used in the anaphora resolution learning operation (described later) and the anaphora resolution learning operation (described later) as a clue for predicting the antecedent probability in anaphora resolution. Meanwhile, the explanation of a specific example of the event sequence model builder 2 is given later in detail.

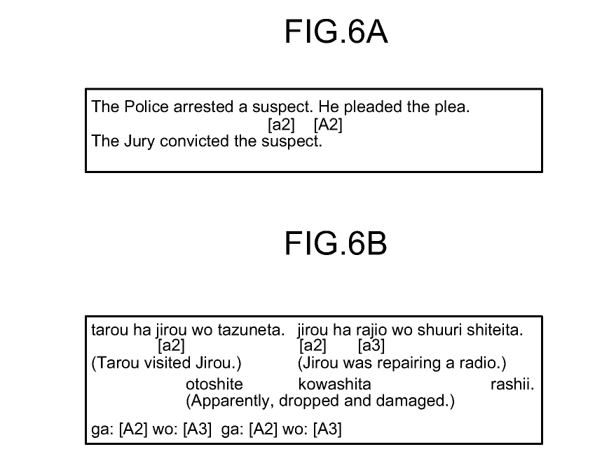

At the time of performing the anaphora resolution learning operation in the contextual analysis device 100, the anaphora-tagged document group D3 is input to the case frame predictor 1. FIG. 6 is a diagram for explaining examples of the anaphora-tagged document group D3. FIG. 6A illustrates a partial extract of English sentences, while FIG. 6B illustrates a partial extract of Japanese sentences. An anaphora tag is a tag indicating the correspondence relationship between an antecedent and an anaphors in the sentences. In the examples illustrated in FIG. 6, tags starting with uppercase “A” represent anaphor candidates, while tags starting with lowercase “a” represent antecedent candidates. Thus, among the tags representing the anaphor candidates and the tags representing the antecedent candidates, the tags having identical numbers are in a correspondence relationship with each other. In the example of Japanese sentences illustrated in (b) in FIG. 6, the anaphors are omitted. Hence, the anaphor tags are attached to the predicate portions in the sentences along with case classification information of the anaphors.

Upon receiving the anaphora-tagged document group D3, in an identical manner to receiving the arbitrary document group D1, the case frame predictor 1 predicts, with respect to each predicate included in the anaphora-tagged document group D3, a case frame to which that predicate belongs; and outputs case frame information and anaphora-tagged document group D3′ in which case frame information representing a brief overview of the top-k candidate case frames is attached to each predicate.

Then, the machine-learning case example generator 3 receives the case frame information and the anaphora-tagged document group D3′, and generates the training-purpose case example data D4 from the case frame information and the anaphora-tagged document group D3′ using the event sequence model D2 generated by the event sequence model builder 2. Meanwhile, the detailed explanation of a specific example of the machine-learning case example generator 3 is given later.

Subsequently, the anaphora resolution trainer 4 performs training for machine learning with the training-purpose case example data D4 as the input, and generates the anaphora resolution learning model D5 as the learning result. Meanwhile, in the embodiment, it is assumed that a binary classifier is used as the anaphora resolution trainer 4. Since machine learning using a binary classifier is a known technology, the detailed explanation is not given herein.

In the case of performing the anaphora resolution predicting operation in the contextual analysis device 100, the analysis target document D6 is input to the case frame predictor 1. The analysis target document D6 represents target application data for anaphora resolution. Upon receiving the analysis target document D6, in an identical manner to receiving the arbitrary document group D1 or the anaphora-tagged document group D3, the case frame predictor 1 predicts, with respect to each predicate included in the analysis target document D6, a case frame to which that predicate belongs; and outputs case-frame-information-attached analysis target document D6′ in which case frame information representing a brief overview of the top-k candidate case frames is attached to each predicate.

Then, the machine-learning case example generator 3 receives the case-frame-information-attached analysis target document D6′, and generates the prediction-purpose case example data D7 from the case-frame-information-attached analysis target document D6′ using the event sequence model D2 generated by the event sequence model builder 2.

Subsequently, with the prediction-purpose case example data D7 as the input, the anaphora resolution predictor 5 performs machine learning using the anaphora resolution learning model D5 generated by the anaphora resolution trainer 4; and generates the anaphora resolution prediction result D8 as a result. Generally, this output serves as the output of the application. Meanwhile, in the embodiment, it is assumed that a binary classifier is used as the anaphora resolution predictor 5, and the detailed explanation is not given herein.

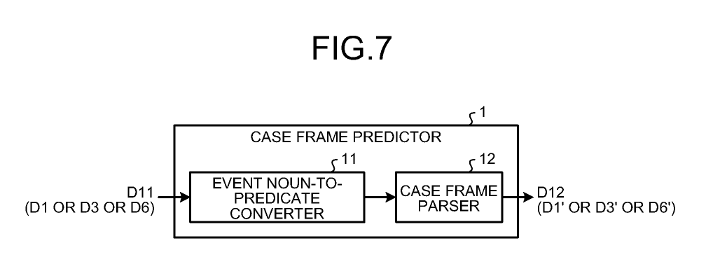

Given below is the explanation of a specific example of the case frame predictor 1. FIG. 7 is a block diagram illustrating a configuration example of the case frame predictor 1. As illustrated in FIG. 7, the case frame predictor 1 includes an event noun-to-predicate converter 11 and a case frame parser 12. The input to the case frame predictor 1 is either the arbitrary document group D1, or the anaphora-tagged document group D3, or the analysis target document D6; while the output from the case frame predictor 1 is either the case-frame-information-attached document group D1′, or the case frame information and the anaphora-tagged document group D3′, or the case-frame-information-attached analysis target document D6′. Meanwhile, hereinafter, for the purpose of illustration, a group of documents or documents input to the case frame predictor 1 are collectively termed as a pre-case-frame-prediction document D11; while documents output from the case frame predictor 1 are collectively termed as a post-case-frame-prediction document D12.

The event noun-to-predicate converter 11 performs an operation of replacing the event nouns included in the pre-case-frame-prediction document D11, which has been input, with predicate expressions. This operation is performed on the backdrop of having a purpose of increasing the case examples of predicates. In the embodiment, the event sequence model builder 2 generates the event sequence model D2, and the machine-learning case example generator 3 generates the training-purpose case example data D4 and the prediction-purpose case example data D7 using the event sequence model D2. At that time, greater the number of case examples of predicates; better becomes the performance of the event sequence model D2. Hence, it becomes possible to generate more suitable training-purpose case example data D4 and more suitable prediction-purpose case example data D7, and to enhance the accuracy of machine learning. Thus, as a result of using the event noun-to-predicate converter 11 for the purpose of replacing the event nouns with predicate expressions, it becomes possible to enhance the accuracy of machine learning.

For example, when the pre-case-frame-prediction document D11 is written in Japanese, the event noun-to-predicate converter 11 performs an operation of substituting nominal verbs for such verbs in the sentences which are formed by adding “suru” (to do) to nouns. More particularly, when a verb formed by adding “suru” to a noun “nichibeikoushou” (Japan-U.S. negotiations) is present in the pre-case-frame-prediction document D11, that verb is replaced with a phrase “nichibei ga koushou suru” (Japan and U.S. hold trade negotiations). In order to perform such an operation, it is necessary to determine whether or not the concerned noun is an event noun and what is the argument of the event noun. Generally, such an operation is a difficult operation to perform. In this regard, however, there exists a corpus such as the NAIST text corpus (http://cl.naist.jp/nldata/corpus/) in which annotations are given about the relationship between the event nouns and the arguments. Using such a corpus, it becomes possible to easily perform the abovementioned operation with the use of annotations. In the example of “nichibeikoushou” (Japan-U.S. trade negotiations), the annotation indicates that “koushou” (negotiations) is an event noun, and the “ga” case argument of “koushou” (negotiations) is “nichibei” (Japan-U.S.).

Meanwhile, the event noun-to-predicate converter 11 is an optional feature that is used as may be necessary. In the case of not using the event noun-to-predicate converter 11, the pre-case-frame-prediction document D11 is input without modification to the case frame parser 12.

The case frame parser 12 detects, from the pre-case-frame-prediction document D11, predicates including the predicates obtained by the event noun-to-predicate converter 11 by converting event nouns; and then predicts the case frames to which the detected predicates belong. As far as Japanese language is concerned, a tool such as KNP (http://nlp.ist.i.kyoto-u.ac.jp/index.php?KNP) has been released that has the function of predicting the case frames to which the predicates in the sentences belong. Thus, KNP is a Japanese syntax/case analysis system that makes use of the Kyoto University Case Frames mentioned above and has the function of predicting the case frames to which the predicates in the sentences belong. In the embodiment, it is assumed that the case frame parser 12 implements an identical algorithm to KNP. Meanwhile, since the case frames predicted by the case frame parser 12 represent only the prediction result, it is not necessary that a single case frame is uniquely determined with respect to a single predicate. In that regard, with respect to a single predicate, the case frame parser 12 predicts the top-k candidate case frames and attaches case frame information, which represents a brief overview of the top-k candidate case frames, as the annotation to each predicate. Meanwhile, “k” is a positive number and, for example, k=5 is set.

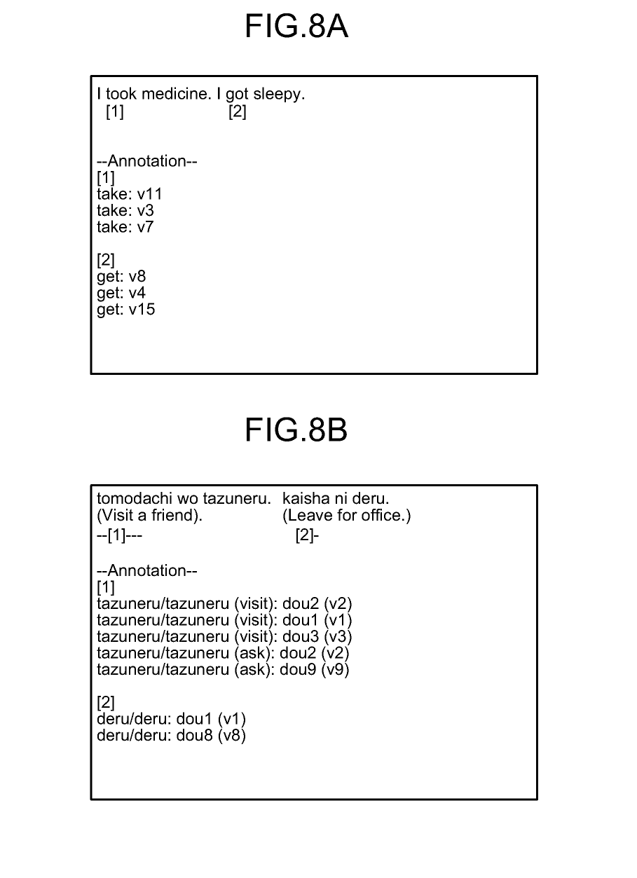

The result of having the case frame information, which represents a brief overview of the top-k candidate case frames, attached as the annotation to each predicate detected from the pre-case-frame-prediction document D11 is the post-case-frame-prediction document D12. Moreover, the post-case-frame-prediction document D12 serves as the output of the case frame predictor 1. FIG. 8 is a diagram for explaining examples of the post-case-frame-prediction document D12. FIG. 8A illustrates a partial extract of English sentences, while FIG. 8B illustrates a partial extract of Japanese sentences. In the post-case-frame-prediction document D12, the case frame information that is attached as the annotation contains a label which enables identification of the word senses of the predicate. In the English sentences illustrated in FIG. 8A; v11, v3, and v7 are labels that enable identification of the word senses of the predicate. In the Japanese sentences illustrated in FIG. 8B; dou2 (v2), dou1 (v1), dou3 (v3), dou2 (v2), and dou9 (v9) are labels that enable identification of the word senses of the predicate and that correspond to the labels used in the Kyoto University Case Frames.

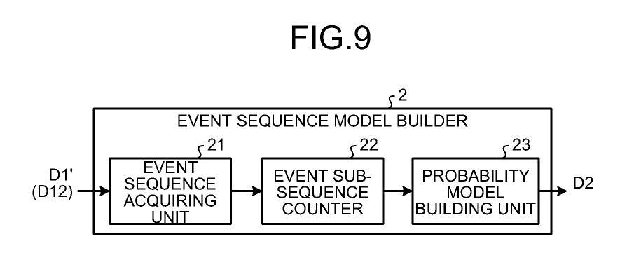

Given below is the explanation of a specific example of the event sequence model builder 2. FIG. 9 is a block diagram illustrating a configuration example of the event sequence model builder 2. As illustrated in FIG. 9, the event sequence model builder 2 includes an event sequence acquiring unit (a sequence acquiring unit) 21, an event sub-sequence counter (a frequency calculator) 22, and a probability model building unit (a probability calculator) 23. The event sequence model builder 2 receives input of the case-frame-information-attached document group D1′ (the post-case-frame-prediction document D12) and outputs the event sequence model D2.

The event sequence acquiring unit 21 acquires a group of event sequences from the case-frame-information-attached document group D1′. As described above, each event sequence in the group of event sequences acquired by the event sequence acquiring unit 21 is attached with the word sense identification information, which enables identification of predicates, in addition to the conventional event sequence elements. That is, from the case-frame-information-attached document group D1′, the event sequence acquiring unit 21 detects a plurality of predicates having a common argument (the anchor). Then, with respect to each detected predicate, the event sequence acquiring unit 21 obtains, as the element, a combination of the predicate, the word sense identification information, and the case classification information. Subsequently, in order of appearance of the predicates, the event sequence acquiring unit 21 arranges the elements obtained for the predicates in the case-frame-information-attached document group D1′; and obtains an event sequence. Herein, of the case frame information given as the annotation in the case-frame-information-attached document group D1′, the labels enabling identification of the word senses of the predicates are used as the word sense identification information of the elements of the event sequence. For example, in the example of English language; the labels v1, v3, and v7 included in the case frame information illustrated in FIG. 8A are used as the word sense identification information. In the example of Japanese language; the labels dou2 (v2), dou1 (v1), dou3 (v3), dou2 (v2), and dou9 (v9) included in the case frame information illustrated in FIG. 8B are used as the word sense identification information.

Regarding the method by which the event sequence acquiring unit 21 acquires the group of event sequences from the case-frame-information-attached document group D1′, it is possible to implement a method in which a coreference-tag anchor is used or a method in which a surface anchor is used.

Firstly, the explanation is given about the method in which the group of event sequences is acquired using a coreference-tag anchor. In this method, the premise is that the case-frame-information-attached document group D1′ that is input to the event sequence acquiring unit 21 has coreference tags attached thereto. Herein, the coreference tags may be attached from beginning to the arbitrary document group D1 input to the case frame predictor 1, or the coreference tags may be attached to the case-frame-information-attached document group D1′ after it is obtained from the arbitrary document group D1 but before it is input to the event sequence model builder 2.

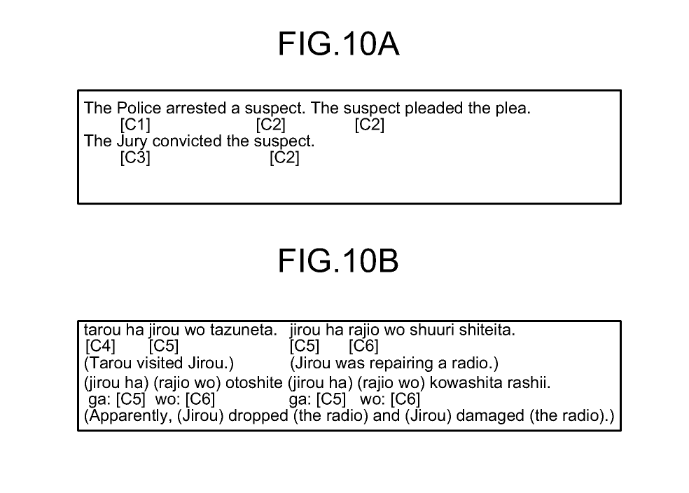

Given below is the explanation about the coreference tags. FIG. 10 is a diagram for explaining examples of the coreference-tagged documents. FIG. 10A illustrates an example of English sentences, while FIG. 10B illustrates an example of Japanese sentences. A coreference tag represents information that enables identification of the nouns having a coreference relationship. Herein, the nouns having a coreference relationship are made identifiable by attaching the same label to them. In the example of English language illustrated in FIG. 10A, “C2” appears at three locations thereby indicating that the respective nouns have a coreference relationship. The set of nouns having a coreference relationship is called a coreference cluster. In the example of Japanese language illustrated in FIG. 10B, in an identical manner to the example of English language illustrated in FIG. 10A, it is indicated that the nouns having the same label attached thereto have a coreference relationship. However, in the case of Japanese language, omission of important words due to zero anaphora is a frequent occurrence. Hence, the coreference relationship is determined only after resolving zero anaphora. Thus, in the example illustrated in FIG. 10B, the Japanese phrases written in brackets are supplemented by means of zero anaphora resolution.

Given below is the explanation of an anchor. As described above, an anchor is a common argument shared among a plurality of predicates. In the case of using coreference tags, a coreference cluster having the size of two or more is searched and the group of nouns included in that coreference cluster is treated as the anchor. As a result of identifying the anchor using coreference tags, it becomes possible to eliminate an inconvenience in which a group of nouns matching on the surface but differing in substance are treated as the anchor or to eliminate an inconvenience in which a group of nouns matching in substance but differing only on the surface are not treated as the anchor.

In the case of acquiring an event sequence using the coreference-tag anchor, the event sequence acquiring unit 21 firstly picks the group of nouns from the coreference cluster and treats the group of nouns as the anchor. Then, from the case-frame-information-attached document group D1′, the event sequence acquiring unit 21 detects the predicate of a plurality of sentences in which the anchor is present, identifies the type of the case of the slot in which the anchor is placed in each sentence, and obtains the case classification information. Subsequently, from the case frame information attached as the annotation to each detected predicate in the case-frame-information-attached group D1′, the event sequence acquiring unit 21 refers to the label that enables identification of the word sense of that predicates and obtains the word sense identification information of the predicate. Then, with respect to each of a plurality of predicates detected from the case-frame-information-attached group D1′, the event sequence acquiring unit 21 obtains, as the element, a combination of the predicate, the word sense identification information, and the case classification information. Subsequently, the event sequence acquiring unit 21 arranges the elements in order of appearance of the predicates in the case-frame-information-attached document group D1′ and obtains an event sequence. Meanwhile, in the embodiment, as described above, the case frame information of the top-k candidates is attached to a single predicate. For that reason, a plurality of sets of word sense identification information is obtained with respect to a single predicate. Hence, in each element constituting the event sequence, a plurality of combination candidates (element candidates) is present differing only in the word sense identification information.

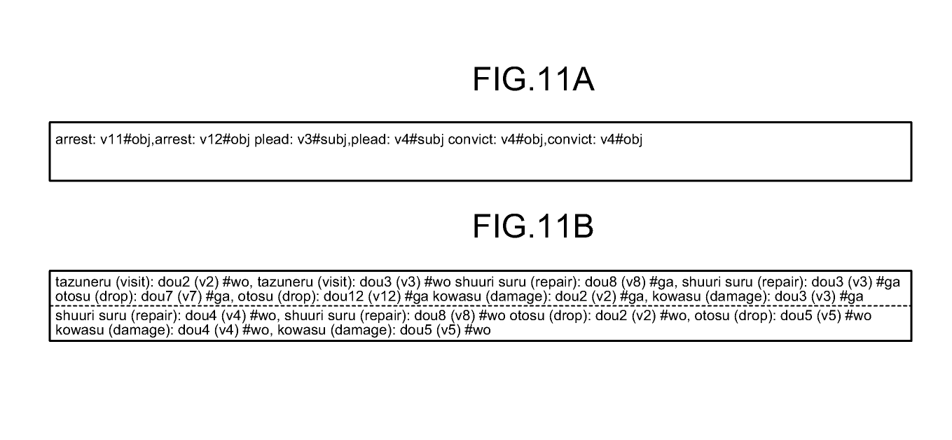

The event sequence acquiring unit 21 performs the operations described above with respect to all coreference clusters, and obtains a group of event sequences that represents the set of anchor-by-anchor event sequences. FIG. 11 is a diagram illustrating examples of event sequences acquired from the coreference-tagged documents illustrated in FIG. 10. FIG. 11A illustrates an event sequence in which the word “suspect” present in the English sentences illustrated in FIG. 10A serves as the anchor. Moreover, in FIG. 11B, the upper portion illustrates an event sequence in which the word “jirou” (Jirou: a name) present in the Japanese sentences illustrated in FIG. 10B serves as the anchor; while the lower portion illustrates an event sequence in which the word “rajio (radio)” present in the Japanese sentences illustrated in FIG. 10B serves as the anchor. Regarding the notation for the event sequences illustrated in FIG. 11, each element in an event sequence is separated by a blank space, and element candidates for individual elements are separated using commas. Thus, each event sequence is a sequence of elements each of which has a plurality of element candidates reflecting the case frame information of the top-k candidates with respect to each predicate. In the example illustrated in FIG. 11, k=2 is set.

Given below is the explanation of a method of acquiring an event sequence using a surface anchor. In this method, there is no assumption that the case-frame-information-attached document group D1′ that is input to the event sequence acquiring unit 21 has coreference tags attached thereto. Instead, it is considered that, in the case-frame-information-attached document group D1′ that is input to the event sequence acquiring unit 21, the nouns matching on the surface have coreference relationship. For example, in the example of English sentences illustrated in FIG. 10A, if it is assumed that coreference tags [C1], [C2], and [C3] are not attached, then the noun “suspect” appearing at three locations matches on the surface. Hence, it is considered that the noun “suspect” at those three locations has coreference relationship. In the case of Japanese sentences, in an identical manner to the example given earlier, surface-based coreference relationship is determined only after resolving zero anaphora. More particularly, for example, a zero anaphora tag representing the relationship between the zero pronoun and the antecedent is attached to the case-frame-information-attached document group D1′; the zero pronoun indicated by the zero anaphora tag is supplemented with the antecedent; and then a surface-based coreference relationship is determined. The subsequent operations are identical to the case of acquiring an event sequence using a coreference-tag anchor.

With respect to each event sequence acquired by the event sequence acquiring unit 21, the event sub-sequence counter 22 counts the frequency of appearance of each sub-sequence in that event sequence. A sub-sequence is a partial set of N number of elements from among the elements included in the event sequence, and forms a part of the event sequence. Thus, a single event sequence includes a plurality pf sub-sequences according to the combination of N number of elements. Herein, “N” represents the length of a sub-sequence (the number of elements constituting a sub-sequence). Moreover, the number of sub-sequences is set to a suitable number from the perspective of treating the sub-sequences as procedural knowledge.

With respect to the sub-sequence that includes the leading element of the event sequence; it is possible to use <s>, which represents a space, in one or more elements anterior to that sub-sequence so that the sub-sequence has N number of elements including the spaces <s>. With that, it becomes possible to express that the leading element of the event sequence is appearing at the start of the event sequence. Similarly, with respect to the sub-sequence having the last element of the event sequence; it is possible to use <s>, which represents a space, in one or more elements posterior to that sub-sequence so that the sub-sequence has N number of elements including the spaces <s>. With that, it becomes possible to express that the leading element of the event sequence is appearing at the end of the event sequence.

Meanwhile, in the embodiment, the configuration is such that the group of event sequences is acquired from the case-frame-information-attached document group D1′ without limiting the number of elements, and subsets of N number of elements are picked from each event sequence. However, alternatively, at the time of acquiring the group of event sequences from the case-frame-information-attached group D1′, it is possible to have a limitation that each event sequence includes only N number of elements. In this case, the event sequences that are acquired from the case-frame-information-attached group D1′ themselves serve as the sub-sequences. In other words, when the event sequences are acquired without any limit on the number of elements, the sub-sequences picked from those event sequences are equivalent to the event sequences that are acquired under a limitation on the number of elements.

As far as the methods of obtaining sub-sequences from an event sequences are concerned, one method is to obtain the subsets of adjacent N number of elements of the event sequence, while the other method is to obtain subsets of N number of elements without imposing the restriction that the elements need to be adjacent. The model for counting the frequency of appearance of the sub-sequences obtained according to the latter method is particularly called the skip model. Since the skip model allows combinations of non-adjacent elements, it offers a merit of being able to deal with sentences in which there is a temporary break in context due to, for example, interrupts.

With respect to each event sequence acquired by the event sequence acquiring unit 21, the event sub-sequence counter 22 picks all sub-sequences having the length N. Then, for each type of sub-sequences, the event sub-sequence counter 22 counts the frequency of appearance. That is, from among the group of sub-sequences that represents the set of all sub-sequences picked from an event sequence, the event sub-sequence counter 22 counts the frequency at which the sub-sequences having the same arrangement of elements appear. When counting of the frequency of appearance of the sub-sequences is performed for all event sequences, the event sub-sequence counter 22 outputs a frequency list that contains the frequency of appearance for each sub-sequence.

However, as described above, each element constituting an event sequence has a plurality of element candidates differing only in the word sense identification information. For that reason, the frequency of appearance of sub-sequences needs to be counted for each combination of element candidates. In order to obtain the frequency of appearance for each combination of element candidates with respect to a single sub-sequence; for example, a value obtained by dividing the number of counts of the frequency of appearance of the sub-sequence by the number of combinations of element candidates can be treated as the frequency of appearance of each combination of element candidates. That is, with respect to each element constituting the sub-sequence, all combinations available upon selecting a single element candidate are obtained as sequences, and the value obtained by dividing the number of counts of the frequency of appearance of the sub-sequence by the number of obtained sequences is treated as the frequency of appearance of each sequence. For example, assume that a sub-sequence A-B includes an element A and an element B; assume that the element A has element candidates a1 and a2; and assume that the element B has element candidates b1 and b2. In this case, the sub-sequence A-B is expanded into four sequences, namely, a1-b1, a2-b1, a1-b2, and a2-b2. Then, the value obtained by dividing the number of counts of the sub-sequence A-B by 4 is treated as the frequency of appearance of each of the sequences a1-b1, a2-b1, a1-b2, and a2-b2. Thus, if the number of counts of the frequency of appearance of the sub-sequence A-B is one, then the frequency of appearance of each of the sequences a1-b1, a2-b1, a1-b2, and a2-b2 is equal to 0.25.

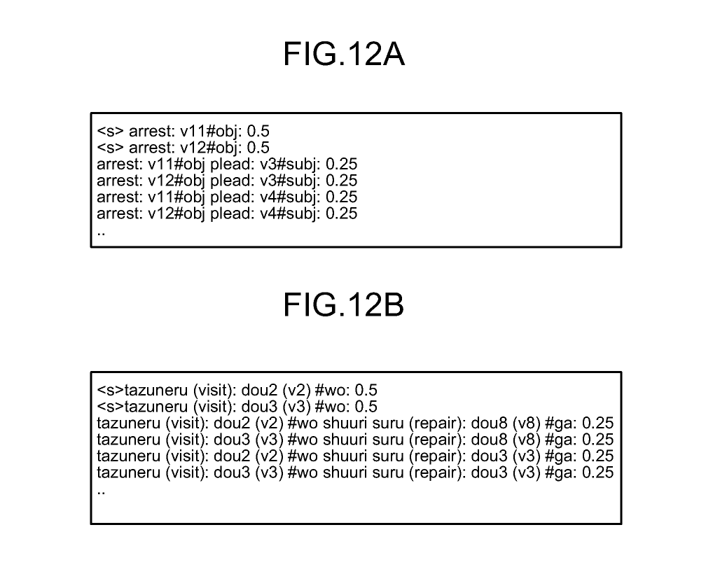

FIG. 12 is a diagram illustrating portions of the frequency lists obtained from the event sequences illustrated in FIG. 11. FIG. 12A illustrates an example of the frequency list representing the frequency of appearance of some of the sub-sequences picked from the event sequence illustrated in FIG. 11A. Moreover, FIG. 12B illustrates an example of the frequency list representing the frequency of appearance of some of the sub-sequences picked from the event sequence illustrated in FIG. 11B. In the example illustrated in FIG. 12, the length N of the sub-sequences is set to two, and the number of counts of the appearance of frequency of the sub-sequences is one. In the frequency lists illustrated in FIG. 12A and FIG. 12B, the left side of the colons in each line indicates the sub-sequences expanded for each combination of element candidates, and the right side of the colons in each line indicates the frequency of appearance of the respective sequences.

The probability model building unit 23 refers to the frequency list output by the event sub-sequence counter 22, and builds a probability model (the event sequence model D2). Regarding the method by which the probability model building unit 23 builds a probability model, there is the method of using the n-gram model, or the method of using the trigger model in which the order of elements is not taken into account.

Firstly, the explanation is given about the method of building a probability model using the n-gram model. When target sequences for probability calculation are expressed as {x1, x2, . . . , xn} and the frequency of appearance of the sequences is expressed as c(•); then an equation for calculating the probability using the n-gram model is given below as Equation (1).

p(xₙ|xₙ₋₁, . . . ,x₁|)=c(x₁, . . . ,xₙ)/c(x₁, . . . ,xₙ₋₁) (1)

In the case of building a probability model using the n-gram model, the probability model building unit 23 performs calculation according to Expression 1 with respect to all sequences for which the frequency of appearance is written in the frequency list output by the event sub-sequence counter 22; and calculates the probability of appearance for each sequence. Then, the probability model building unit 23 outputs a probability list in which the calculation results are compiled. Moreover, as an optional operation, it is also possible to perform any existing smoothing operation.

Given below is the explanation about the method of building a probability model using the trigger model. When target sequences for probability calculation are expressed as {x1, x2, . . . , xn} and the frequency of appearance of the sequences is expressed as c(•); then an equation for calculating the probability using the n-gram model is given below as Equation (2), which represents the sum of point-wise mutual information (PMI).

$$\begin{matrix}Trigger ( {x}_{1} , {x}_{2} , … {x}_{n} ) = {\sum }_{1 \leq i , j \leq n} pmi ( {x}_{i} , {x}_{j} ) \\ = {\sum }_{1 \leq i , j \leq n} ln p ( i \vert j ) + ln p ( j \vert i )\end{matrix} \qquad ( 2 )$$

In Equation (2), “ln” represents logarithm natural; and the value of p(xi|xj) and p(xj|xi) are obtained from Bigram model: p(x2|x1)=c(x1, x2)/c(x1).

In the case of building a probability model using the trigger model, the probability model building unit 23 performs calculations according to Expression 2 with respect to all sequences for which the frequency of appearance is written in the frequency list output by the event sub-sequence counter 22; and calculates the probability of appearance for each sequence. Then, the probability model building unit 23 outputs a probability list in which the calculation results are compiled. Moreover, as an optional operation, it is also possible to perform any existing smoothing operation. Furthermore, if the length N is set to be equal to two, then the calculation of the sum (in Equation 2, the calculation involving “Σ”) becomes redundant, thereby making Equation 2 equivalent to the conventional calculation using PMI.

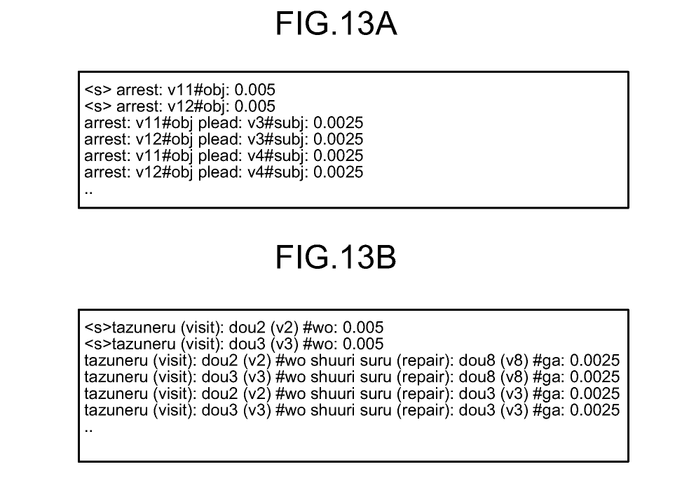

FIG. 13 is a diagram illustrating probability lists that are the output of probability models built using the frequency lists illustrated in FIG. 12. FIG. 13A illustrates an example of the probability list obtained from the frequency list illustrated in FIG. 12A; while FIG. 13B illustrates an example of the probability list obtained from the frequency list illustrated in FIG. 12B. In the frequency lists illustrated in FIGS. 13A and 13B, the left side of the colons in each line indicates the sub-sequences expanded for each combination of element candidates, and the right side of the colons in each line indicates the frequency of appearance of the respective sequences. A probability list as illustrated in FIG. 13 serves as the event sequence model D2, which is final output of the event sequence model builder 2.

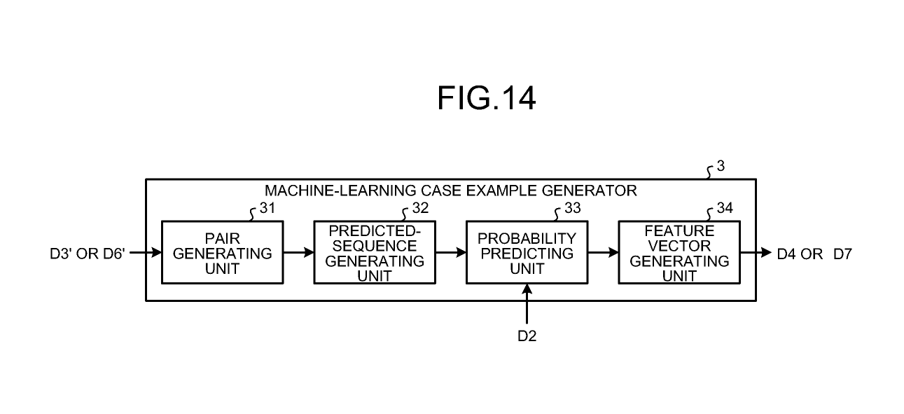

Given below is the explanation of a specific example of the machine-learning case example generator 3. FIG. 14 is a block diagram illustrating a configuration example of the machine-learning case example generator 3. As illustrated in FIG. 14, the machine-learning case example generator 3 includes a pair generating unit 31, an predicted-sequence generating unit 32, a probability predicting unit 33, and a feature vector generating unit 34. When the learning operation for anaphora resolution is to be performed, the input to the machine-learning case example generator 3 is the case frame information, the anaphora-tagged document group D3′, and the event sequence model D2. On the other hand, when the prediction operation for anaphora resolution is to be performed, the input to the machine-learning case example generator 3 is the case-frame-information-attached analysis target document D6′ and the event sequence model D2. Moreover, when the learning operation for anaphora resolution is to be performed, the output of the machine-learning case example generator 3 is the training-purpose case example data D4. On the other hand, when the prediction operation for anaphora resolution is to be performed, the output of the machine-learning case example generator 3 is the prediction-purpose case example data D7.

The pair generating unit 31 generates pairs of an anaphor candidate and an antecedent candidate using the case frame information and the anaphora-tagged document group D3′ or using the case-frame-information-attached analysis target document D6′. When the learning operation for anaphora resolution is to be performed, in order to eventually obtain the training-purpose case example data D4, the pair generating unit 31 generates a positive example pair as well as a negative example pair using the case frame information and the anaphora-tagged document group D3′. Herein, a positive example pair represents a pair that actually has an anaphoric relationship, while a negative example pair represents a pair that does not have an anaphoric relationship. Meanwhile, the positive example pair and the negative example pair can be distinguished using anaphora tags.

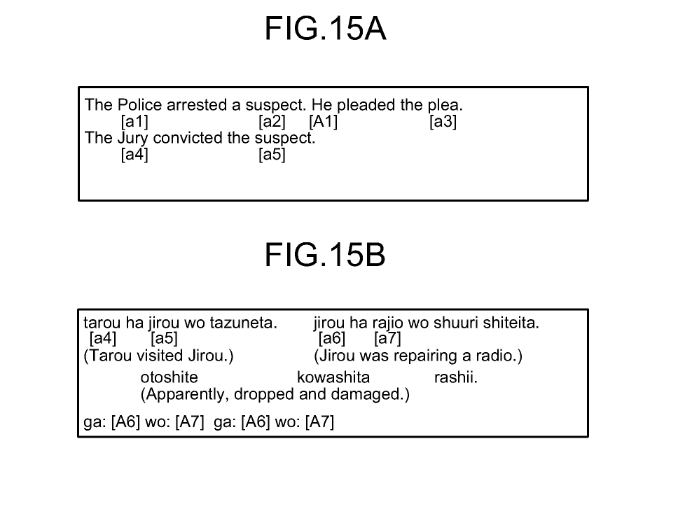

Explained below with reference to FIG. 15 is a specific example of the operations performed by the pair generating unit 31 in the case in which the learning operation for anaphora resolution is to be performed. FIG. 15 is a diagram illustrating examples of anaphora-tagged sentences. FIG. 15A illustrates English sentences and FIG. 15B illustrates Japanese sentences. In the examples illustrated in FIG. 15, in an identical manner to the examples illustrated in FIG. 6, tags starting with uppercase “A” represent anaphor candidates; tags starting with lowercase “a” represent antecedent candidates; and an anaphor candidate tag and an antecedent candidate tag that have identical numbers are in a correspondence relationship.

The pair generating unit 31 generates pairs of all combinations of anaphor candidates and antecedent candidates. However, any antecedent candidate paired with an anaphor candidate needs to be present in the preceding context as compared to that anaphor candidate. From the English sentences illustrated in FIG. 15A, the following group of pairs of an anaphor candidate and an antecedent candidate is obtained: {(a1, A1), (a2, A1)}. Similarly, from the Japanese sentences illustrated in FIG. 15B, the following group of pairs of an anaphor candidate and an antecedent candidate is obtained: {(a4, A6), (a5, A6), (a6, A6), (a7, A6), (a4, A7), (a5, A7), (a6, A7), (a7, A7), (a4, A6), (a5, A6), (a6, A6), (a7, A6), (a4, A7), (a5, A7), (a6, A7), (a7, A7)}. Meanwhile, in order to achieve efficiency in the operations, it is possible to add a condition by which antecedent candidates separated from an anaphor candidate by a predetermined distance or more are not considered for pairing with that anaphor candidate. Then, from the group of pairs obtained in this manner, the pair generating unit 31 attaches a positive example label to positive example pairs and attaches a negative example label to negative example pairs.

Meanwhile, when the prediction operation for anaphora resolution is to be performed, the pair generating unit 31 generates pairs of an anaphor candidate and an antecedent candidate using the case-frame-information-attached target document D6′. In this case, since the case-frame-information-attached target document D6′ does not have anaphora tags attached thereto, the pair generating unit 31 needs to somehow find the antecedent candidates and the anaphor candidates in the sentences. If the case-frame-information-attached target document D6′ is in English; then it is possible to think of a method in which, for example, part-of-speech analysis is performed with respect to the case-frame-information-attached target document D6′, and the words determined to be pronouns are treated as anaphor candidates and all other nouns are treated as antecedent candidates. If the case-frame-information-attached target document D6′ is in Japanese; then it is possible to think of a method in which, for example, predicate argument structure analysis is performed with respect to the case-frame-information-attached target document D6′, the group of predicates is detected, and the slots of requisite cases not filled by any predicate are treated as anaphor candidates and the nouns present in the preceding context to the anaphor candidates are treated as antecedent candidates. Upon finding the antecedent candidates and the anaphor candidates in the abovementioned manner, the pair generating unit 31 obtains a group of pairs of an anaphor candidate and an antecedent candidate in an identical manner to obtaining the group of pairs in the case in which the learning operation for anaphora resolution is to be performed. However, herein, it is not required to attach positive example labels and negative example labels.

With respect to each pair of an anaphor candidate and an antecedent candidate, the predicted-sequence generating unit 32 predicts a case frame to which belongs the predicate in the sentence in which the anaphor candidate is replaced with the antecedent candidate; as well as extracts the predicates in the preceding context with the antecedent candidate serving as the anchor and generates an event sequence described above. In the event sequence generated by the predicted-sequence generating unit 32, a combination of the predicate in the sentences when the anaphor candidate is replaced with the antecedent candidate, the word sense identification information, and the case classification information is the last element of the sequence; and that last element is obtained by means of prediction. Hence, it is called an predicted sequence to differentiate from the event sequence acquired from the arbitrary document group D1.

Given below is the detailed explanation of a specific example of the operations performed by the predicted-sequence generating unit 32. Herein, the predicted-sequence generating unit 32 performs the operations with respect to each pair of an anaphor candidate and an antecedent candidate generated by the pair generating unit 31.

Firstly, with respect to the predicates of the sentences to which the anaphor candidate belongs, the predicted-sequence generating unit 32 assigns not the anaphor candidate but the antecedent candidate as the argument, and then predicts the case frame for the predicates. This operation is performed using an existing case frame parser. However, the case frame parser used herein needs to predict the case frame using the same algorithm as the algorithm of the case frame parser 12 of the case frame predictor 1. Consequently, with respect to a single predicate, case frames of the top-k candidates are obtained. Herein, the case frame of the top-1 candidate is used.

Then, from the case frame information and the anaphora-tagged document group D3′ or from the case-frame-information-attached analysis target document D6′, the predicted-sequence generating unit 32 detects a group of nouns that are present in the preceding context as compared to the antecedent candidate and that have a coreference relationship with the antecedent candidate. The determination of the coreference relationship is either performed using a coreference analyzer, or the nouns matching on the surface are treated to have coreference. The group of nouns obtained in this manner serves as the anchor.

Subsequently, from the case frame information and the anaphora-tagged document group D3′ or from the case-frame-information-attached analysis target document D6′, the predicted-sequence generating unit 32 detects the predicates of the sentences to which the anchor belongs and generates an predicted sequence in an identical manner to the method implemented by the event sequence acquiring unit 21. However, the length of predicted sequence is set to N in concert with the length of the sub-sequences present in the event sequence. That is, as the predicted sequence, a sequence is generated in which the elements corresponding to the predicates in the sentences to which the antecedent candidate belongs are connected to the element corresponding to each of the N−1 number of predicates detected in the preceding context. The predicted-sequence generating unit 32 performs this operation with respect to all pairs of an anaphora candidate and an antecedent candidate generated by the pair generating unit 31, and generates an predicted sequence corresponding to each pair.

The probability predicting unit 33 collates each predicted sequence, which is generated by the predicted-sequence generating unit 32, with the event sequence model D2; and predicts the occurrence probability of each predicted sequence. More particularly, the probability predicting unit 33 searches the event sequence model D2 for the sub-sequence matching with an predicted sequence, and treats the frequency of appearance of that sub-sequence as the occurrence probability of the predicted sequence. The occurrence probability of an predicted sequence represents the probability (likelihood) of the pair of an anaphora candidate and an antecedent candidate used in generating the predicted sequence to have a coreference relationship. Meanwhile, if no sub-sequence in the event sequence model D2 is found to match with an predicted sequence, then the occurrence probability of that predicted sequence is set to zero. Moreover, if a smoothing operation has been performed while generating the event sequence model D3; then it becomes possible to reduce the occurrence of a case in which a matching sub-sequence to an predicted sequence is not found.

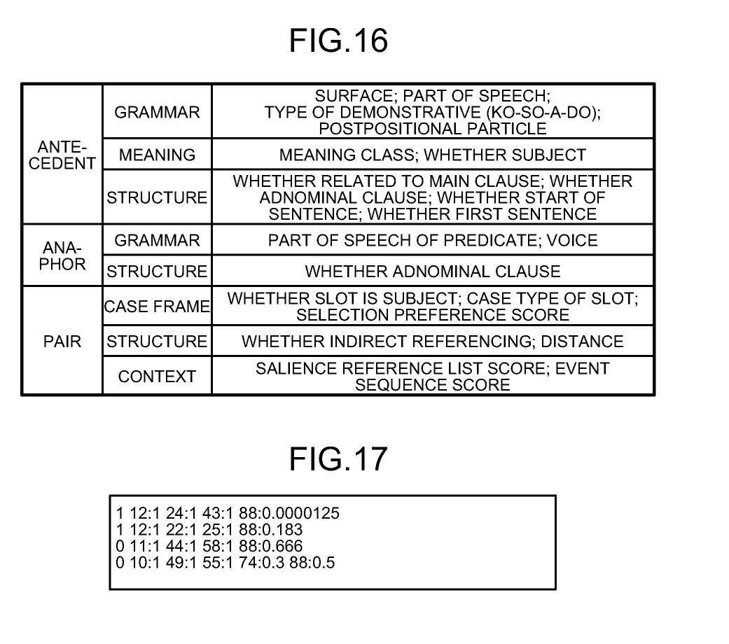

The feature vector generating unit 34 treats the pairs of an anaphora candidate and an antecedent candidate, which are generated by the pair generating unit 31, as case examples; and, with respect to each case example, generates a feature vector in which the occurrence probability of the predicted sequence generated by the predicted-sequence generating unit 32 is added as one of the elements (one of the features). Thus, in addition to using a standard group of features that is generally used as the elements of a feature vector representing the pair of an anaphor candidate and an antecedent candidate, that is, in addition to using a group of features illustrated in FIG. 16 for example; the feature vector generating unit 34 uses the occurrence probability of the predicted sequence obtained by the probability predicting unit 33 and generates a feature vector related to the case example representing the pair of the anaphor candidate and the antecedent candidate.

In the case in which the prediction operation for anaphora resolution is to be performed, the feature vector generated by the feature vector generating unit 34 becomes the prediction-purpose case example data D7 that is the final output of the machine-learning case example generator 3. Moreover, in the case of performing the learning operation for anaphora resolution, when the positive example label or the negative example label, which has been attached to the pair of an anaphora candidate and the antecedent candidate, is added to the feature vector generated by the feature vector generating unit 34; the result becomes the training-purpose case example data D4 that is the final output of the machine-learning case example generator 3.

FIG. 17 is a diagram illustrating an example of the training-purpose case example data D4. In the example illustrated in FIG. 17, the leftmost item represents the positive example label or the negative example label, and all other items represent the elements of the feature vector. Regarding each element of the feature vector, the number written on the left side of the colon indicates an element number, while the number written on the right side of the color indicates the value (the feature) of that element. In the example illustrated in FIG. 17, an element number “88” is assigned to the occurrence probability of the predicted sequence. As the value of the element represented by the element number “88”, the occurrence probability of the predicted sequence obtained by the probability predicting unit 33 is indicated. Meanwhile, regarding the prediction-purpose case example data D7, the leftmost item can be filled with a dummy value that is ignored during the machine learning operation.

The training-purpose case example data D4 that is output from the machine-learning case example generator 3 is input to the anaphora resolution trainer 4. Then, using the training-purpose case example data D4, the anaphora resolution trainer 4 performs machine learning with a binary classifier and generates the anaphora resolution learning model D5 serving as the learning result. Moreover, the prediction-purpose case example data D7 that is output from the machine-learning case example generator 3 is input to the anaphora resolution predictor 5. Then, using the anaphora resolution learning model D5 and the prediction-purpose case example data D7 generated by the anaphora resolution trainer 4, the anaphora resolution predictor 5 performs machine learning with a binary classifier and outputs the anaphora resolution prediction result D8.

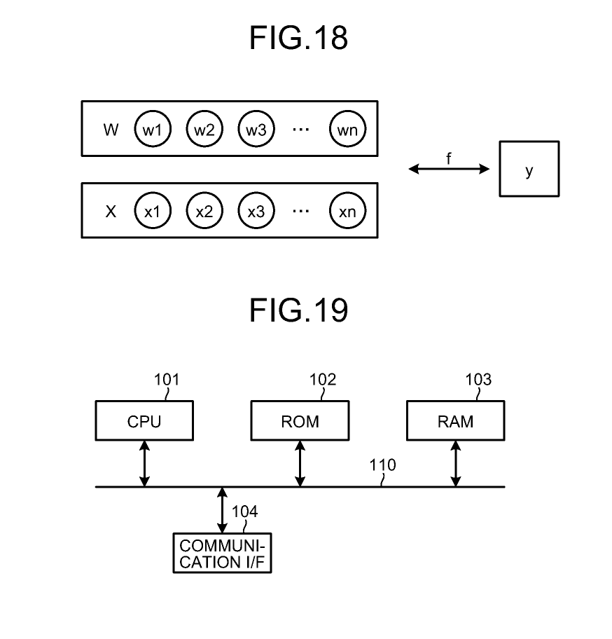

FIG. 18 is a schematic diagram for conceptually explaining the operation of determining the correctness of a case example by performing machine learning with a binary classifier. During the machine learning with a binary classifier, as illustrated in FIG. 18, from the inner product of each element {x1, x2, x3, . . . , xn} of a feature vector X of the case example and a weight vector W (w1, w2, w3, . . . , w4), a score value y of the case example is obtained using a function f; and the score value y is compared with a predetermined threshold value to determine the correctness of the case example. Herein, the score value y of the case example can be expressed as y=f(X; W).

The training for machine learning as performed by the anaphora resolution trainer 4 indicates the operation of obtaining the weight vector W using the training-purpose case example data D4. That is, the anaphora resolution trainer 4 is provided with, as the training-purpose case example data D4, the feature vector X of the case example and a positive example label or a negative label indicating the result of threshold value comparison of the score value y of the case example; and obtains the weight vector W using the provided information. The weight vector W becomes the anaphora resolution learning model D5.

The machine learning performed by the anaphora resolution predictor 5 includes calculating the score value y of the case example using the weight vector W provided as the anaphora resolution learning model D5 and using the feature vector X provided as the prediction-purpose case example data D7; comparing the score value y with a threshold value; and outputting the anaphora resolution prediction result D8 that indicates whether or not the case example is correct.

As described above in detail with reference to specific examples, in the contextual analysis device 100 according to the embodiment, anaphora resolution is performed using not only the predicate and the case classification information but also a new-type event sequence that is a sequence of elements that additionally include the word sense identification information which enables identification of the word sense of the predicate. For that reason, it becomes possible to perform anaphora resolution with accuracy.

Moreover, in the contextual analysis device 100 according to the embodiment, an event sequence is acquired that is a sequence of elements having a plurality of element candidates differing only in the word sense identification information; the frequency of appearance of the event sequence is calculated for each combination of element candidates; and the probability of appearance of the event sequence is calculated for each combination of element candidates. Hence, during case frame prediction, it becomes possible to avoid the cutoff phenomenon that occurs when only the topmost word sense identification information is used. That enables achieving enhancement in the accuracy of anaphora resolution.

Furthermore, in the contextual analysis device 100 according to the embodiment, in the case in which the probability of appearance of an event sequence is calculated using the n-gram model, it becomes possible to obtain the probability of appearance of the event sequence by taking into account an effective number of elements as procedural knowledge. That enables achieving further enhancement in the accuracy of the event sequence as procedural knowledge.

Moreover, in the contextual analysis device 100 according to the embodiment, in the case in which the probability of appearance of an event sequence is calculated using the trigger model, it also becomes possible to deal with a change in the order of appearance of elements. Hence, for example, even with respect to a document in which transposition has occurred, it becomes possible to obtain the probability of appearance of an event sequence that serves as effective procedural knowledge.

Furthermore, in the contextual analysis device 100 according to the embodiment, at the time of obtaining sub-sequences from an event sequence, it is allowed to have combinations of non-adjacent elements in a sequence. As a result, even with respect to sentences in which there is a temporary break in context due to interrupts, it becomes possible to obtain sub-sequences that serve as effective procedural knowledge.

Moreover, in the contextual analysis device 100 according to the embodiment, at the time of acquiring an event sequence from the arbitrary document group D1, the anchor is identified using coreference tags. As a result, it becomes possible to eliminate an inconvenience in which a group of nouns matching on the surface but differing in substance are treated as the anchor or to eliminate an inconvenience in which a group of nouns matching in substance but differing only on the surface are not treated as the anchor.

Each of the abovementioned functions of contextual analysis device 100 according to the embodiment can be implemented by, for example, executing predetermined computer programs in the contextual analysis device 100. In that case, for example, as illustrated in FIG. 19, the contextual analysis device 100 has the hardware configuration of a normal computer that includes a control device such as a central processing unit (CPU) 101, memory devices such as a read only memory (ROM) 102 and a random access memory (RAM) 103, a communication I/F 104 that establishes connection with a network and performs communication, and a bus 110 that connects the constituent elements with each other.

The computer programs executed in the contextual analysis device 100 according to the embodiment are recorded as installable or executable files in a computer-readable recording medium such as a compact disk read only memory (CD-ROM), a flexible disk (FD), a compact disk readable (CD-R), or a digital versatile disk (DVD); and are provided as a computer program product.

Alternatively, the computer programs executed in the contextual analysis device 100 according to the embodiment can be stored in a downloadable manner on a computer connected to a network such as the Internet or can be distributed over a network such as the Internet.

Still alternatively, the computer programs executed in the contextual analysis device 100 according to the embodiment can be stored in advance in the ROM 102.

Meanwhile, the computer programs executed in the contextual analysis device 100 according to the embodiment contain module for each processing unit (the case frame predictor 1, the event sequence model builder 2, the machine-learning case example generator 3, the anaphora resolution trainer 4, and the anaphora resolution predictor 5). As far as the actual hardware is concerned, for example, the CPU 101 (a processor) reads the computer programs from the memory medium and runs them such that the computer programs are loaded in a main memory device. As a result, each constituent element is generated in the main memory device. Meanwhile, in the contextual analysis device 100 according to the embodiment, some or all of the operations described above can be implemented using dedicated hardware such as an application specific integrated circuit (ASIC) or a field-programmable gate array (FPGA).

In the contextual analysis device 100 described above, the event sequence model building operation, the anaphora resolution learning operation, as well as the anaphora resolution predicting operation is performed. However, alternatively, the contextual analysis device 100 can be configured to perform only the anaphora resolution predicting operation. In that case, the event sequence model building operation and the anaphora resolution learning operation are performed in an external device. Then, along with receiving input of the analysis target document D6, the contextual analysis device 100 receives input of the event sequence model D2 and the anaphora resolution learning model D5 from the external device; and then performs anaphora resolution with respect to the analysis target document D6.

Still alternatively, the contextual analysis device 100 can be configured to perform only the anaphora resolution learning operation and the anaphora resolution predicting operation. In that case, the event sequence model building operation is performed in an external device. Then, along with receiving input of the anaphora-tagged document group D3 and the analysis target document D6, the contextual analysis device 100 receives input of the event sequence model D2 from the external device; and generates the anaphora resolution learning model D5 and performs anaphora resolution with respect to the analysis target document D6.

Herein, the contextual analysis device 100 is configured to perform particularly anaphora resolution as contextual analysis. Alternatively, for example, the contextual analysis device 100 can be configured to perform other contextual analysis, such as consistency resolution or dialogue processing, other than anaphora resolution. Even in the case in which the configuration enables performing contextual analysis other than anaphora resolution, if a new-type event sequence is used as a sequence of elements including the word sense identification information which enables identification of the word sense of the predicates, it becomes possible to enhance the accuracy of contextual analysis.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A contextual analysis device comprising:
an predicted-sequence generator configured to generate, from a target document for analysis, an predicted sequence in which some elements of a sequence having a plurality of elements arranged therein are obtained by prediction, each element being a combination of a predicate having a common argument, word sense identification information for identifying word sense of the predicate, and case classification information indicating a type of the common argument;
a probability predictor configured to predict an occurrence probability of the predicted sequence based on a probability of appearance of the sequence that is acquired in advance from an arbitrary group of documents and that is matching with the predicted sequence; and
an analytical processor configured to perform contextual analysis with respect to the target document for analysis by using the predicted occurrence probability of the predicted sequence.

2. The device according to claim 1, wherein the analytical processor is configured to perform anaphora resolution with respect to the target document for analysis by machine learning using the predicted occurrence probability of the predicted sequence as a feature of the predicted sequence.

3. The device according to claim 1, further comprising:
a sequence acquiring unit configured to acquire the sequence from an arbitrary group of documents; and
a probability calculator configured to calculate a probability of appearance of the sequence that has been acquired.

4. The device according to claim 3, wherein the sequence acquiring unit is configured to
detect a plurality of predicates having a common argument from the arbitrary group of documents,
obtain, as the element, a combination of the predicate, the word sense identification information, and the case classification information with respect to each of the plurality of detected predicates, and
arrange the plurality of elements obtained for the plurality of predicates in order of appearance of the predicates in the arbitrary group of documents to acquire the sequence.

5. The device according to claim 3, further comprising a frequency calculator configured to calculate the frequency of appearance of the sequence that has been acquired, wherein
the probability calculator calculates the probability of appearance of the sequence based on the frequency of appearance of the sequence.

6. The device according to claim 5, wherein
the sequence acquiring unit is configured to predict a plurality of word senses with respect to a single predicate and acquire the sequence in which a plurality of elements having a plurality of element candidates differing only in the word sense identification information is arranged, and
the frequency calculator is configured to calculate a frequency of appearance of each combination of the element candidates by dividing the frequency of appearance of the sequence by the number of combinations of the element candidates.

7. The device according to claim 5, wherein the probability calculator is configured to calculate the probability of appearance of the sequence based on an Nth-order Markov process.

8. The device according to claim 5, wherein the probability calculator is configured to calculate the probability of appearance of the sequence based on a sum of point-wise mutual information related to a pair of arbitrary elements of the sequence.

9. The device according to claim 5, wherein
the frequency calculator is configured to calculate the frequency of appearance for each sub-sequence that is a subset of N number of elements of the sequence, and
the probability calculator is configured to calculate the probability of appearance for each of the sub-sequences.

10. The device according to claim 9, wherein the frequency calculator is configured to obtain the sub-sequences in which combinations of non-adjacent elements of the sequences is allowed.

11. The device according to claim 4, wherein
the group of documents is attached with coreference information that enables identification of nouns having a coreference relationship, and
the sequence acquiring unit is configured to identify the common argument based on the coreference information.

12. A contextual analysis method implemented in a contextual analysis device, the method comprising:
generating, from a target document for analysis, an predicted sequence in which some elements of a sequence having a plurality of elements arranged therein are obtained by prediction, each element being a combination of a predicate having a common argument, word sense identification information for identifying word sense of the predicate, and case classification information indicating a type of the common argument;
predicting an occurrence probability of the predicted sequence based on a probability of appearance of the sequence that is acquired in advance from an arbitrary group of documents and that is matching with the predicted sequence; and
performing contextual analysis with respect to the target document for analysis by using the predicted occurrence probability of the predicted sequence.
